(19) United States
(12) Patent Application Publication
(10) Pub. No.: US 2010/0098460 A1
(43) Pub. Date: Apr. 22, 2010

(54) FIXING DEVICE AND IMAGE FORMATION APPARATUS THAT EFFICIENTLY REMOVES RESIDUAL TONER ON INTERMEDIATE TRANSFER BELT

(75) Inventors: Hidetoshi Noguchi, Tahara-shi (JP); Satoru Shibuya, Chiryu-shi (JP); Kazuyoshi Hara, Itami-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/562,706

(22) Filed: Sep. 18, 2009

(30) Foreign Application Priority Data
Oct. 21, 2008 (JP) 2008-271203

(51) Int. Cl. G03G 15/30

(52) U.S. Cl. 399/149

(57) ABSTRACT

Disclosed is an image formation apparatus for forming an image by transferring, onto a recording sheet, a toner image that has been transferred from an image carrier onto an intermediate transfer belt 11, the image formation apparatus comprising: a cleaning member 91 that has electrical conductivity, that is provided on an outside of a rotation path of the belt 11, and that is operable to remove residual toner on the belt 11 by coming into contact with a circumferential surface of the belt 11; a driven roller 13 that is provided on an inside of the rotation path and that faces an inner circumferential surface of the belt 11 in a position opposite from the cleaning member 91; a power supply 96 operable to apply voltage to the cleaning member 91 and the driven roller 13 such that the residual toner is electrically attracted to the cleaning member 91, wherein the driven roller 13 includes an elastic member 13b whose surface is in contact with the belt 11.

This application is based on an application No. 2008-271203 filed in Japan, the content of which is hereby incorporated by reference.

### BACKGROUND OF THE INVENTION

1. Field of the Invention

The present invention relates to a technique for cleaning an intermediate transfer belt in an image formation apparatus that transfers, onto a recording sheet, a toner image that has been transferred from an image carrier to the intermediate transfer belt.

2. Description of Related Art

Among electrophotographic image formation apparatuses, there is an apparatus of a so-called intermediate transfer type that forms an image by first transferring a toner image formed on a surface of a photosensitive drum onto an intermediate transfer belt and then transferring the toner image onto a recording sheet. In this intermediate transfer type image formation apparatus, toner that has not been transferred from the intermediate transfer belt onto the recording sheet remains on the intermediate transfer belt (hereinafter toner that remains in this manner is referred to as “residual toner”), which negatively affects image formation that is performed later on. In order to avoid this situation, the intermediate transfer type image formation apparatus generally includes a cleaning mechanism for removing toner that remains on the intermediate transfer belt after a toner image has been transferred-onto the recording sheet.

A conventional cleaning mechanism includes, for example, a toner collector 1090 and a normal polarity charger 1080, as shown in FIG. 7. The toner collector 1090 is provided in a position opposite from a driven roller 1013 via an intermediate transfer belt 1011, and the normal polarity charger 1080 is provided more upstream in a rotation direction of the belt (shown by arrow A) than the toner collector 1090.

The normal polarity charger 1080 charges, to normal polarity (negative polarity), oppositely charged toner 1030 that is positively charged toner included in the residual toner on the intermediate transfer belt 1011, by applying, to a conductive brush 1081, a voltage having the same polarity as polarity (negative polarity) to which the toner is supposed to be charged. This causes each of the residual toner particles to have its original charge polarity (negative polarity), resulting in improving efficiency of the toner collector 1090 cleaning the residual toner.

The toner collector 1090 includes a conductive fur brush 1091 that is electrically connected to a positive terminal of power supply 1096 via a metallic scraper 1095, and generates electric field between the fur brush 1091 and the grounded driven roller 1013.

The effect of the electric field (i.e., Coulomb force) causes the negatively charged residual toner on the intermediate transfer belt 1011 to be stuck to the fur brush 1091 and further attracted and scraped off by the scraper 1095, so as to be removed from the intermediate transfer belt 1011.

Here, the intermediate transfer belt 1011 is usually formed by using an extrusion method since it is cost-effective. However, this method causes a back surface of the belt to have recessed portions.

Therefore, as shown in an enlarged diagram of a main portion at the bottom of FIG. 7, there are gaps 1011b in recessed portions of the back surface of the intermediate transfer belt 1011 that is in contact with a circumferential surface of the driven roller 1013. Due to the gaps, an electric field in each of the gaps is weaker than that in the other portions of the intermediate transfer belt 1011 that are firmly attached to the circumferential surface of the driven roller 1013. As a result, electric field intensity between the fur brush 1091 and the driven roller 1013 becomes uneven as schematically shown by the hollow arrows in FIG. 7.

When the electric field intensity is uneven, the attraction of the residual toner also becomes uneven, resulting in some of the residual toner remaining on a surface of the intermediate transfer belt 1011 by not being perfectly attracted by the fur brush 1091.

### SUMMARY OF THE INVENTION

The present invention has been made in view of the above-described problems. An object of the present invention is to provide an image formation apparatus that efficiently removes residual toner on an intermediate transfer belt even if a back surface of the intermediate transfer belt has recessed portions.

The above-described object is fulfilled by an image formation apparatus for forming an image by transferring, onto a recording sheet, a toner image that has been transferred from an image carrier onto a first surface of a belt, the image formation apparatus comprising: a cleaning member that has electrical conductivity and is operable to remove residual toner on the first surface of the belt by coming into contact with the first surface; an opposing member that faces a second surface of the belt in a position opposite from the cleaning member, the second surface being a back surface of the first surface; a voltage applicator operable to apply voltage to the cleaning member and the opposing member such that the residual toner is electrically attracted to the cleaning member, wherein the opposing member includes an elastic layer, and a surface of the elastic layer is in contact with the second surface of the belt.

With the stated structure, even if the second surface (the back surface of the first surface onto which the toner image is to be transferred) of the belt has recessed portions, the elastic layer deforms along the surface of the belt that has the recessed portions. In this way, the belt is firmly attached to the opposing member, substantially without any gap, between the elastic layer and the surface that has recessed portions. Since the electrical conductivity (dielectric constant) of the elastic layer that has been formed with a high-polymer material is at least higher than that of air, the intensity of an electric field between the cleaning member and the opposing member is less likely to be varied. This means that the residual toner on the first surface of the belt can be evenly attracted, resulting in the residual toner being efficiently removed.

### BRIEF DESCRIPTION OF THE DRAWINGS

These and other objects, advantages and features of the invention will become apparent from the following description thereof taken in conjunction with the accompanying drawings that illustrate a specific embodiment of the invention.

In the drawings:

FIG. 1 is a schematic cross-sectional diagram showing a structure of a printer according to an embodiment of the present invention;

FIG. 2 is a schematic diagram showing a belt cleaning mechanism according to the embodiment of the present invention;

FIG. 3 is a schematic diagram showing a belt cleaning mechanism according to a modification of the embodiment of the present invention;

FIG. 4 is a schematic diagram showing a belt cleaning mechanism according to a modification of the embodiment of the present invention;

FIG. 5 is a schematic diagram showing a belt cleaning mechanism according to a modification of the embodiment of the present invention;

FIG. 6 is a schematic diagram showing a belt cleaning mechanism according to a modification of the embodiment of the present invention; and

FIG. 7 is a schematic diagram showing a conventional belt cleaning mechanism.

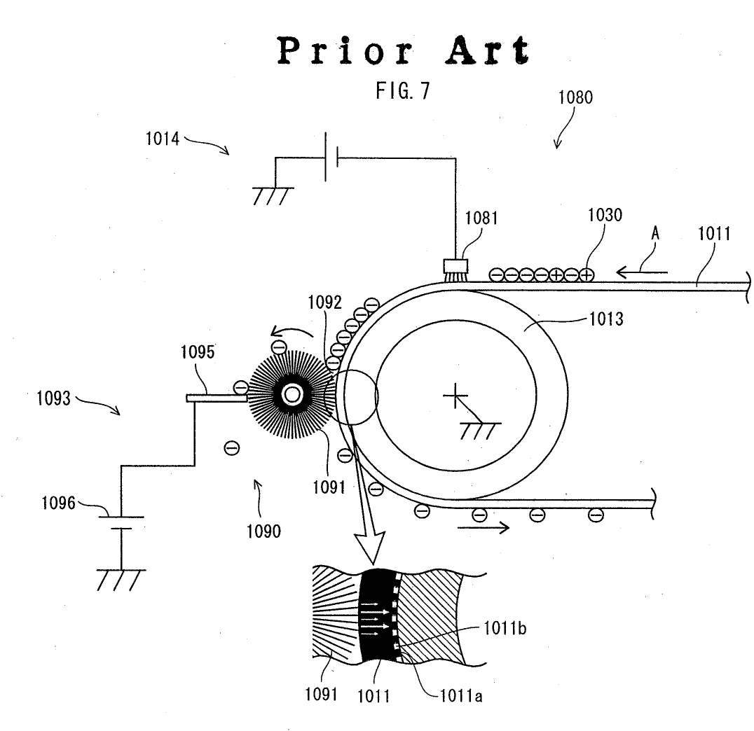

### DESCRIPTION OF PREFERRED EMBODIMENTS

The following describes an embodiment of an image formation apparatus according to the present invention, the image formation apparatus specifically being a tandem digital color printer (hereinafter, simply “printer”) as an example.

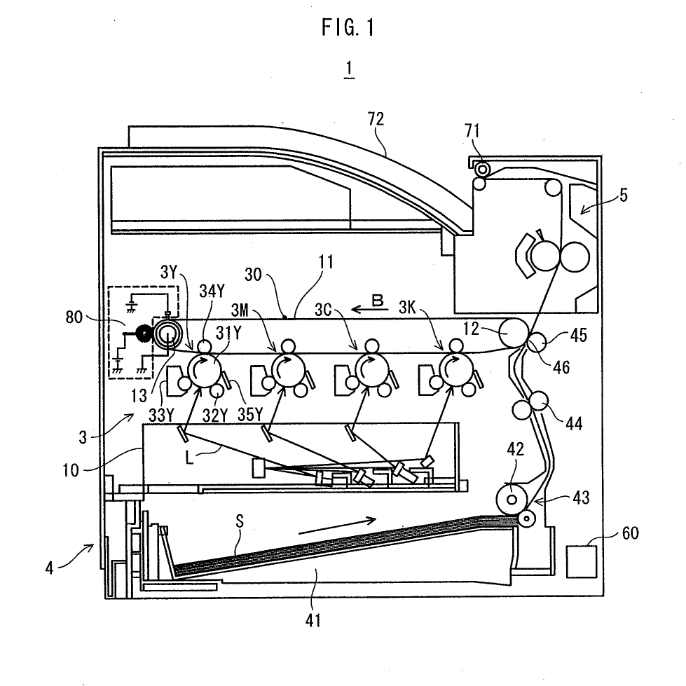

FIG. 1 is a schematic cross-sectional diagram showing an overall structure of a printer 1 according to the present embodiment.

As shown in FIG. 1, the printer 1 is composed of an image processor 3, a feeder 4, a fixer 5, a controller 6, a belt cleaning mechanism, etc., and is connected to a network (e.g., LAN). Upon receiving an instruction to execute a print job from an external terminal apparatus (not illustrated), the printer 1 forms color images composed of yellow, magenta, cyan and black based on the instruction.

Hereinafter, the yellow, magenta, cyan and black reproduction colors are represented as Y, M, C and K, respectively, and the letters Y, M, C, and K are appended to reference numbers relating to the reproduction colors.

The image processor 3 includes: image formers 3Y, 3M, 3C and 3K that respectively correspond to the colors Y, M, C, and K; an optical unit 10; an intermediate transfer belt 11; a belt cleaning mechanism 80; and so on.

The image former 3Y includes: a photosensitive drum 31Y; a charger 32Y; a developer 33Y; a primary transfer roller 34Y; a cleaner 35Y for cleaning the photosensitive drum 31Y; and so on. The charger 32Y, the developer 33Y, the primary transfer roller 34Y, and the cleaner 35Y are all positioned surrounding the photosensitive drum 31Y. The image former 3Y forms a color Y toner image on the photosensitive drum 31Y. Since other image formers 3M to 3K have similar structures to the image former 3Y, the reference numbers of the components of the image formers 3M to 3K are omitted in FIG. 1.

The optical unit 10 includes luminous elements such as laser diodes and polygon mirrors, and emits laser beams L for scanning beams on photosensitive drums 31 of the respective image formers 3Y to 3K.

The intermediate transfer belt 11 is, for example, an endless belt whose electrical resistivity is adjusted to be in the range of 1.00×10⁹ [Ω·cm] to 1.00×10¹³ [Ω·cm] inclusive, by adding conductive carbon particles to resin such as polycarbonate. The intermediate transfer belt 11 is provided around the driving roller 12 and the driven roller 11, and is driven to rotate in a direction of the arrow B.

The intermediate transfer belt 11 is usually formed by using an extrusion method since it is cost-effective. However, this method causes the back surface of the belt to have recessed portions.

These recessed portions are created due to friction between a product and a mold when the product is extruded from the mold in a process of forming the intermediate transfer belt 11. Meanwhile, a front surface of the belt that is used for transferring toner is finished as a mirror surface.

More specifically, the recessed portions are grooves having a depth of approximately 5 μm to 100 μm, which are formed along a direction of extrusion (perpendicular direction to a longitudinal direction of the intermediate transfer belt 11).

The feeder 4 includes: a paper feed cassette 41 that contains a sheet S that is a recording sheet; a pickup roller 42 that picks up the sheet S of the paper feed cassette 41 and directs the sheet S onto a conveyance path 43, one sheet at a time; a timing roller pair 44 for adjusting a timing to convey the picked sheet S to the secondary transfer position 46; a secondary transfer roller 45; and so on.

The controller 6 converts image signals transmitted from the external terminal apparatus into digital signals for the colors Y to K, thereby generating drive signals for driving the luminous elements of the optical unit 10.

The optical unit 10 uses the drive signals from the controller 6 to emit the laser beams L for the image formation of the colors Y to K, and scans beams on the photosensitive drums 31 of the respective image formers 3Y to 3K.

This exposure scanning forms electrostatic latent images on the photosensitive drums 31 of the respective image formers 3Y to 3K, the photosensitive drums 31 being uniformly charged by the chargers 32.

The electrostatic latent images are developed with use of toner that is negatively charged by the developers 33, and the toner images of the colors Y to K are formed on the photosensitive drums 31.

The toner images of the respective colors are sequentially transferred onto the intermediate transfer belt 11 by electrostatic power acting on the primary transfer rollers 34. At this point, the image forming operation for each color is performed at different timings so that the toner images are superimposed on the same position on the intermediate transfer belt 11.

The toner images of the respective colors that have been superimposed on the intermediate transfer belt 11 are transported to the secondary transfer position 46, by the rotation of the intermediate transfer belt 11 in a direction of the arrow B (hereinafter, “belt rotation direction”).

Meanwhile, the sheet S is fed from the feeder 4 via the timing roller pair 44 at the timing when the toner images of the respective colors that have been superimposed are transported to the secondary transfer position 46. The sheet S is conveyed by sandwiched between the rotationally driven intermediate transfer belt 11 and the secondary transfer roller 45. The toner images on the intermediate transfer belt 11 are collectively secondarily transferred onto the sheet S by electrostatic power acting between the intermediate transfer belt 11 and the secondary transfer roller 45.

The sheet S that has passed the secondary transfer position 46 is conveyed to the fixer 5. After the toner images (unfixed images) on the sheet S are fixed to the sheet S by being heated and pressurized by the fixer 5, the sheet S is ejected onto a tray 72 via the eject roller pair 71.

The belt cleaning mechanism 80 removes residual toner 30 that remains on the intermediate transfer belt 11 by not being secondarily transferred in the secondary transfer position 46, thereby preventing the residual toner 30 from being attached to the sheet S during a print job that is performed later on.

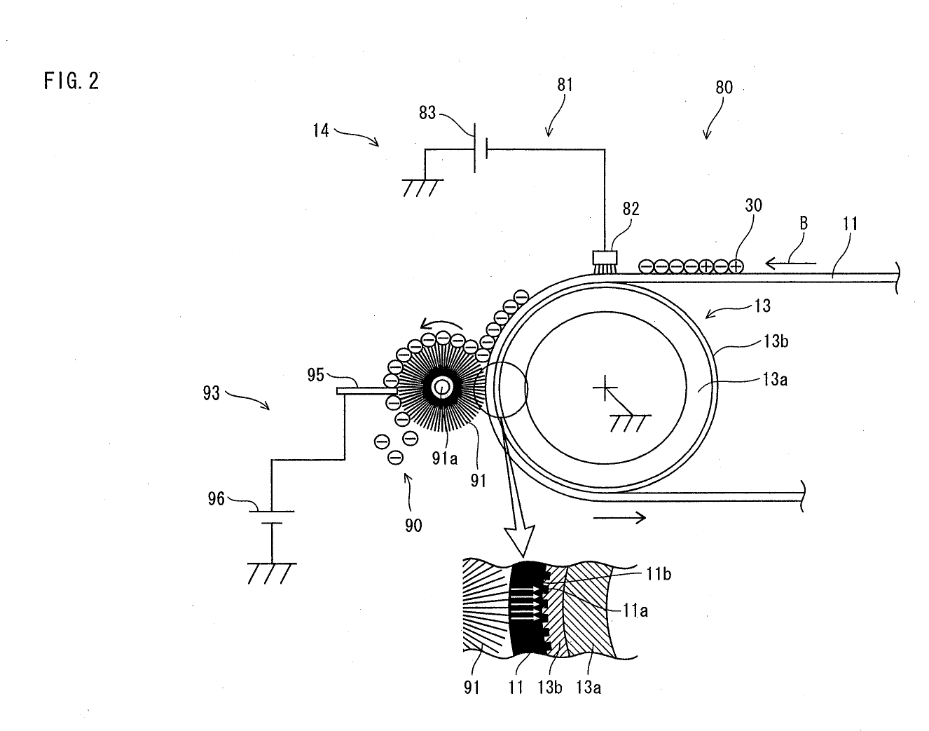

FIG. 2 is a schematic diagram showing the belt cleaning mechanism 80.

As shown in FIG. 2, the belt cleaning mechanism 80 includes a normal polarity charger 81 and a toner collector 90 provided more downstream in the belt rotation direction than the normal polarity charger 81. The belt cleaning mechanism 80 cleans the intermediate transfer belt 11 by removing the residual toner 30 from the intermediate transfer belt 11.

Since this cleaning is performed in conjunction with a driven roller 13, a description of the structure of the driven roller 13 is also provided below.

(Structure of Driven Roller 13)

The driven roller 13 includes: an elastic member 13b having a cylindrical shape; a roller axis 13a that is tightly inserted into the elastic member 13b; and so on.

The roller axis 13a is, for example, a rotatable cylindrical member that has been formed from a highly conductive material such as aluminum. The roller axis 13a is grounded via an axial center (not illustrated) provided at each end of the cylindrical member, and electrical potential is maintained at zero.

The elastic member 13b is a cylindrical member that has been formed from a flexible material. The electrical resistivity of the elastic member 13b is greater than or equal to 1.00×10⁶ [Ω·cm] and the thickness thereof is greater than or equal to 500 μm.

Specifically, such a material is obtained by, for example, adding appropriate amount of conductive carbon particles to a base that is ethylene propylene rubber (EPDM), nitrile butadiene rubber (NBR), or silicon rubber, so that the material has the aforementioned electrical resistivity. The material preferably has an Asker-C hardness in the range of 15 degrees to 80 degrees inclusive.

The aforementioned thickness of the elastic member 13b allows the elastic member 13b to be sufficiently fit in the grooves existing on the back surface of the intermediate transfer belt 11 when the driven roller 13 comes into contact with the intermediate transfer belt 11, which prevents gaps from being formed between the driven roller 13 and the intermediate transfer belt 11.

(Structure of Belt Cleaning Mechanism 80)

The normal polarity charger 81 is used to charge oppositely charged toner, which is included in the residual toner 30 on the intermediate transfer belt 11 in a small amount, to a normal polarity (negative polarity). The normal polarity charger 81 includes: a power supply 83 whose positive terminal is grounded; a conductive brush 82 that is connected to a negative terminal of the power supply 83; and so on.

This makes it possible to provide electrons from the conductive brush 82 to the oppositely charged toner on the intermediate transfer belt 11, resulting in the oppositely charged toner being charged to a normal polarity (negatively charged).

The oppositely charged toner is charged to the normal polarity so as to prevent an inconvenient situation where the residual toner 30 cannot be collectively attracted by Coulomb force because of the oppositely charged toner included in the residual toner 30, resulting in collection efficiency of the residual toner 30 being decreased.

The toner collector 90 uses Coulomb force to attract the residual toner 30 that has been normally charged (negative polarity), and causes the residual toner 30 to be stuck thereto.

More specifically, the toner collector 90 is formed by an inverse voltage applicator 93 being electrically connected to the circumference of a cleaning member 91.

The inverse voltage applicator 93 is electrically connected to the positive terminal of power supply 96, and includes a metallic scraper 95 that is in contact with the circumference of a fur brush 91.

The cleaning member 91 is a fur brush that is in contact with the circumferential surface of the intermediate transfer belt 11, and that is driven by a motor (not illustrated) to rotate in a counter direction to the belt rotation direction. The cleaning member 91 is formed by implanting, in a cloth, bristles that are made of resin and that have an electrical resistivity (per unit of length) approximately in the range of 1.00×10⁴ [Ω·cm] to 1.00×10¹⁰ [Ω·cm] inclusive, and adhering the cloth to the circumferential surface of a core bar 91a with use of a conductive adhesive.

The scraper 95 is a metallic plate provided to be in contact with the circumference of the cleaning member 91.

The power supply 96 has a negative terminal that is grounded and the positive terminal that is connected to the scraper 95. Therefore, a feeble current flows from the scraper 95 to the driven roller 13 that is grounded via the intermediate transfer belt 11. Also, an electric field (hereinafter, “cleaning electric field”) is generated in a direction from the cleaning member 91 to the intermediate transfer belt 11.

As described above, the polarity of the residual toner 30 is uniformly charged to negative polarity. Therefore, Coulomb force that attracts the residual toner 30 electrostatically is generated in a counter direction to the direction of the cleaning electric field.

At this point, as shown in an enlarged diagram of a main portion at the bottom of FIG. 2, the back surface of the intermediate transfer belt 11 opposing the cleaning member 91 is firmly attached to the elastic member 13b having flexibility. In other words, there is no gap or almost no gap between the intermediate transfer belt 11 and the elastic member 13b. Therefore, it is less likely that electrical resistance varies locally. As a result, the intensity of the cleaning electric field becomes equalized, as schematically shown by the hollow arrows in FIG. 2.

This causes the residual toner 30 on the intermediate transfer belt 11 to be stuck to the cleaning member 91 evenly. Then, the residual toner 30 is attracted and scraped off from the cleaning member 91 by the scraper 95, and is collected in a collection container (not illustrated).

As described above, in the printer 1 of the present embodiment, the circumferential surface of the driven roller 13 is covered by the elastic member 13b. Therefore, the back surface of the intermediate transfer belt 11 that opposes the cleaning member 91 is firmly attached to the elastic member 13b of the driven roller 13, substantially without any gap between the back surface of the intermediate transfer belt 11 and the elastic member 13b. This equalizes the intensity of the cleaning electric field, causing Coulomb force that electrostatically attracts the residual toner 30 to act evenly. As a result, when the belt cleaning mechanism 80 electrically attracts and removes the residual toner 30 on the intermediate transfer belt 11, the residual toner 30 is evenly stuck to the cleaning member 91, thereby efficiently removing the residual toner 30.

Note that although negatively charged toner is used in the embodiment described above, it is possible to use positively charged toner.

In this case, a direction of the electric field generated by the normal polarity charger 81, a direction of the cleaning electric field, etc. may be appropriately set in accordance with the intended purpose.

### <Modification>

The present invention is not limited to the above-described embodiment. For example, the following modifications are also acceptable.

(1) In the above embodiment, the belt cleaning mechanism 80 includes the normal polarity charger 81. However, the normal polarity charger 81 is not always necessary. The belt cleaning mechanism 81 may be formed without the normal polarity charger 81.

This is because of the following reason. That is, the residual toner 30 is mainly charged to a normal polarity (negative polarity) and only a small amount of the residual toner 30 is charged to an opposite polarity. Therefore, eliminating the normal polarity charger 81 does not necessarily deteriorate the image quality to a great extent.

(2) Also, even in a case where the belt cleaning mechanism 80 includes the normal polarity charger 81, a structure of the present invention is not limited to the structure described in the above embodiment.

For example, in the above-described embodiment, the conductive brush 82 is electrically connected to the negative terminal of the power supply 83 whose positive terminal is grounded. However, the conductive brush 82 may be directly grounded without the power supply 83 in between, as described in Japanese Patent Application Publication No. 2006-126449.

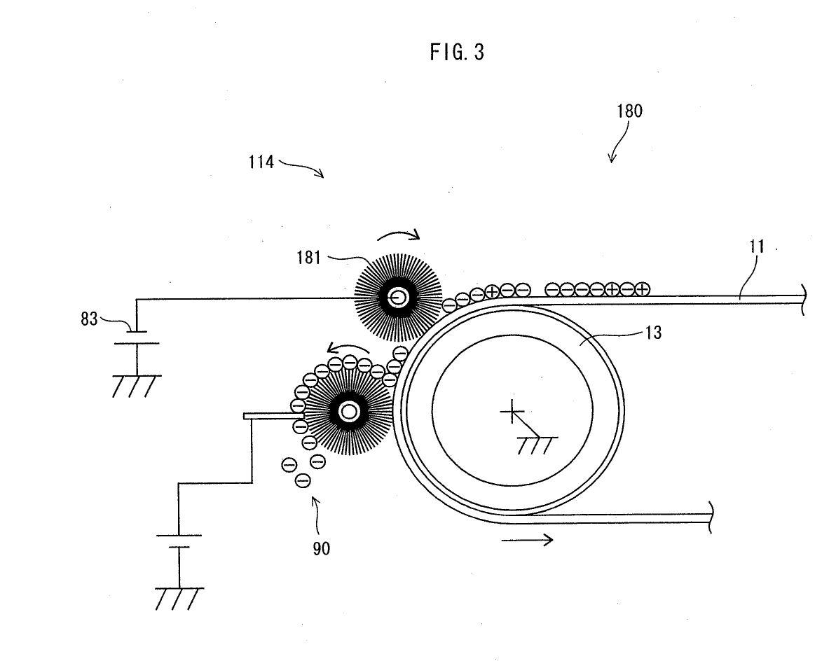

Also, a fur brush 181 that is driven to rotate may be provided instead of the conductive brush 82, as shown in FIG. 3.

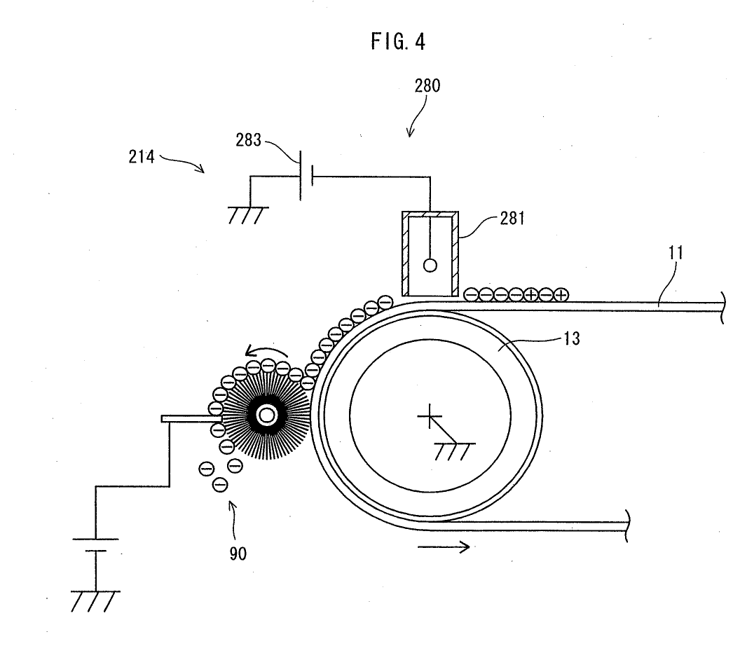

Alternatively, a well-known charger 281 may be provided instead of the conductive brush 82, as shown in FIG. 4. The charger 281 is connected to a high-voltage power supply 283, and uses a corona discharge to charge the residual toner 30 to a normal polarity (negative polarity).

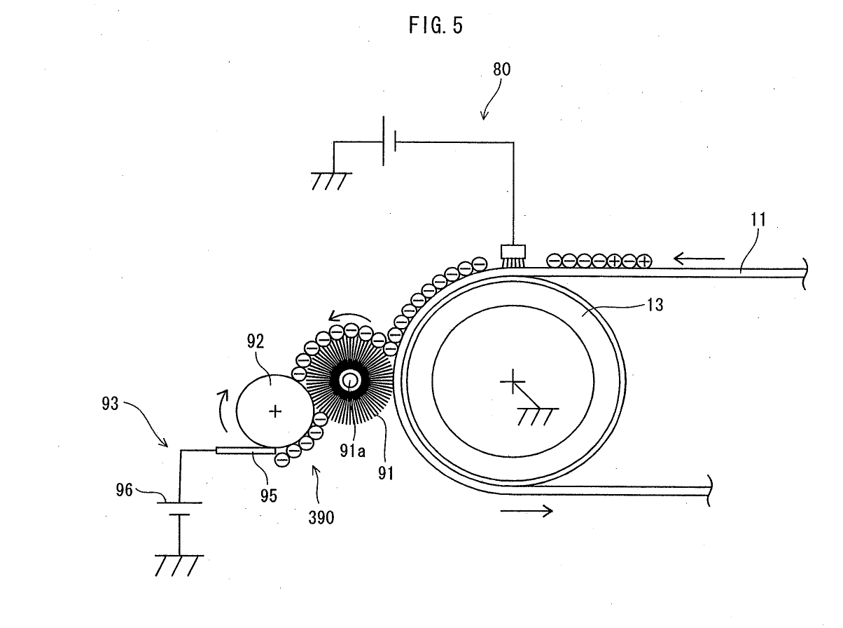

(3) Also, in the above-described embodiment, the toner collector 90 includes the cleaning member 91, the scraper 95, and the power supply 96. However, it is not limited to such. For example, it is possible to provide a collection roller 92 between the cleaning member 91 and the scraper 95, as shown in FIG. 5.

(4) Also, in the above-described embodiment, the driven roller 13 has a structure in which the roller axis 13a is tightly inserted into the cylindrical elastic member 13b. However, it is not limited to such. For example, the circumferential surface of the roller axis 13a may be coated with a flexible material. In short, it is acceptable as long as an elastic layer is provided on the circumferential surface of the roller axis 13a.

(5) Additionally, in the above-described embodiment, the driven roller 13 has a two-piece structure including the roller axis 13a and the elastic member 13b. However, the driven roller 13 may have a one-piece structure. For example, a member having the same shape as the roller axis 13a may be formed with a high-polymer material such as ethylene propylene rubber (EPDM), nitrile butadiene rubber (NBR), or silicon rubber. Then, a forming agent or the like may be added to the circumferential surface of the member, so that the circumferential surface becomes softer than the other parts of the member.

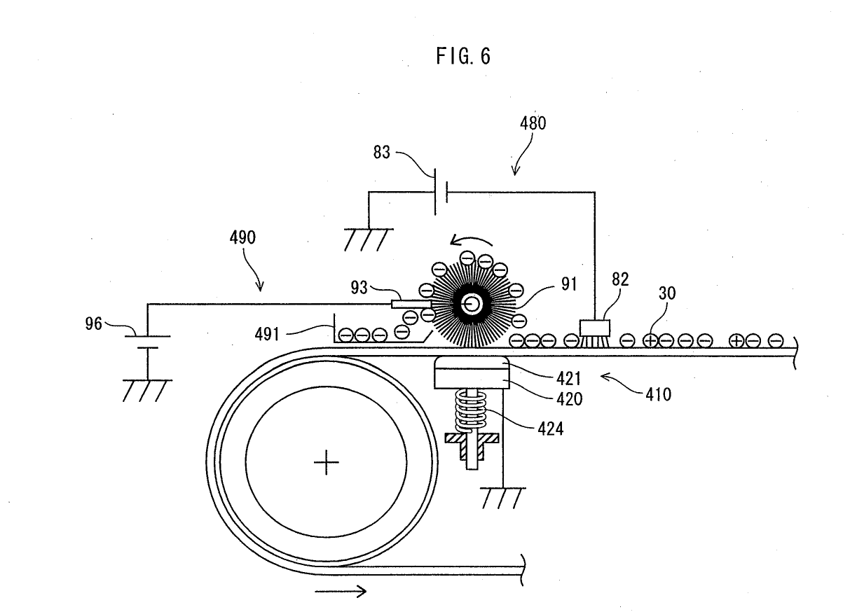

(6) Also, in the above-described embodiment, the driven roller 13 that is grounded cooperates with the belt cleaning mechanism 80 to remove the residual toner 30 on the intermediate transfer belt 11. However, it is not limited to such. For example, it is possible to have a structure shown in FIG. 6. In this structure, a surface of a metallic plate 420 that is grounded is covered with a flexible elastic layer 421, thereby forming a pad 410. The pad 410 is then pressed against the back surface of the intermediate transfer belt 11, so as to provide the pad 410 with the same electrical function as the driven roller 13.

This makes it possible for the pad 410 to be in contact with the intermediate transfer belt 11 that is driven to rotate, substantially without any gap in between.

In this case, the cleaning member 91 needs to be arranged in a position opposite from the pad 410 via the intermediate transfer belt 11.

In accordance with the position of the cleaning member 91, a collection container 491, which collects the residual toner 30 that is stuck to the cleaning member 91, may be arranged in a position close to the cleaning member 91. Also, the conductive brush 82 needs to be arranged more upstream in the belt rotation direction than the cleaning member 91.

In a case where a slide resistance between the pad 410 and the intermediate transfer belt 11 is too large, a surface of the elastic layer 421 may be coated with Teflon so as to increase a sliding characteristic between the pad 410 and the intermediate transfer belt 11.

(7) Also, the present invention may be any combination of the above-described embodiment and the modifications.

The present invention provides an image formation apparatus for forming an image by transferring, onto a recording sheet, a toner image that has been transferred from an image carrier onto a first surface of a belt, the image formation apparatus comprising: a cleaning member that has electrical conductivity and is operable to remove residual toner on the first surface of the belt by coming into contact with the first surface; an opposing member that faces a second surface of the belt in a position opposite from the cleaning member, the second surface being a back surface of the first surface; a voltage applicator operable to apply voltage to the cleaning member and the opposing member such that the residual toner is electrically attracted to the cleaning member, wherein the opposing member includes an elastic layer, and a surface of the elastic layer is in contact with the second surface of the belt.

With the stated structure, even if the second surface (the back surface of the first surface onto which the toner image is to be transferred) of the belt has recessed portions, the elastic layer deforms along the surface of the belt that has the recessed portions. In this way, the belt is firmly attached to the opposing member, substantially without any gap, between the elastic layer and the surface that has recessed portions. Since the electrical conductivity (dielectric constant) of the elastic layer that has been formed with a high-polymer material is at least higher than that of air, the intensity of an electric field between the cleaning member and the opposing member is less likely to be varied. This means that the residual toner on the first surface of the belt can be evenly attracted, resulting in the residual toner being efficiently removed.

Also, it is preferable that the belt is an endless loop, and is provided at least around a driving roller and a driven roller, and the opposing member is preferably the driven roller.

With the stated structure, the tension of the belt causes the back surface of the belt to be pressed against the elastic layer and thereby be deformed. This makes it easier for the belt to be firmly attached to the opposing member.

Also, it is preferable that a hardness of the elastic layer is low to an extent that, when pressed against the second surface with a predetermined pressure, the elastic layer deforms along the second surface that has recessed portions and is attached firmly thereto, substantially without any gap, between the elastic layer and the second surface. More specifically, it is preferable that the elastic layer has an Asker-C hardness in a range of 15 degrees to 80 degrees inclusive.

With the stated structure, it is easier for the belt to be firmly attached to the opposing member more securely.

Furthermore, an electrical resistivity of the belt is preferably in a range of 1.00×10⁹ Ω·cm to 1.00×10¹³ Ω·cm inclusive. It is also preferable that a depth of each recessed portion of the second surface is in a range of 5 μm to 100 μm inclusive. Further, the cleaning member is preferably a fur brush that is driven to rotate in a counter direction to a moving direction of the first surface. Also, the fur brush preferably has bristles made of resin whose electrical resistivity per unit of length is in a range of 1.00×10⁹ Ω·cm to 1.00×10¹³ Ω·cm inclusive.

Although the present invention has been fully described by way of examples with reference to the accompanying drawings, it is to be noted that various changes and modifications will be apparent to those skilled in the art.

Therefore, unless such changes and modifications depart from the scope of the present invention, they should be construed as being included therein.

What is claimed is:

1. An image formation apparatus for forming an image by transferring, onto a recording sheet, a toner image that has been transferred from an image carrier onto a first surface of a belt, the image formation apparatus comprising:
a cleaning member that has electrical conductivity and is operable to remove residual toner on the first surface of the belt by coming into contact with the first surface;
an opposing member that faces a second surface of the belt in a position opposite from the cleaning member, the second surface being a back surface of the first surface;
a voltage applicator operable to apply voltage to the cleaning member and the opposing member such that the residual toner is electrically attracted to the cleaning member, wherein the opposing member includes an elastic layer, and a surface of the elastic layer is in contact with the second surface of the belt.

2. The image formation device of claim 1 wherein
the belt is an endless loop, and is provided at least around a driving roller and a driven roller, and
the opposing member is the driven roller.

3. The image formation apparatus of claim 1 wherein
a hardness of the elastic layer is low to an extent that, when pressed against the second surface with a predetermined pressure, the elastic layer deforms along the second surface that has recessed portions and is attached firmly thereto, substantially without any gap, between the elastic layer and the second surface.

4. The image formation apparatus of claim 1 wherein
the elastic layer has an Asker-C hardness in a range of 15 degrees to 80 degrees inclusive.

5. The image formation apparatus of claim 1 wherein
an electrical resistivity of the belt is in a range of 1.00×10⁹ Ω·cm to 1.00×10¹³ Ω·cm inclusive.

6. The image formation apparatus of claim 3 wherein
a depth of each recessed portion of the second surface is in a range of 5 μm to 100 μm inclusive.

7. The image formation apparatus of claim 1 wherein
the cleaning member is a fur brush that is driven to rotate in a counter direction to a moving direction of the first surface.

8. The image formation apparatus of claim 7 wherein
the fur brush has bristles made of resin whose electrical resistivity per unit of length is in a range of 1.00×10⁹ Ω·cm to 1.00×10¹³ Ω·cm inclusive.
